(19) United States
(12) Patent Application Publication
(10) Pub. No.: US 2025/0103314 A1
(43) Pub. Date: Mar. 27, 2025

(54) DYNAMIC OPTIMIZATION OF SERVICES

(71) Applicant: Dell Products L.P., Round Rock, TX (US)

(72) Inventors: ROMAN BOBER, Ashdod (IL); MAXIM BALIN, Gan-Yavene (IL); DORON BOKOBZA, Mishmar HaNegev (IL)

(21) Appl. No.: 18/471,595

(22) Filed: Sep. 21, 2023

(51) Int. Cl. G06F 8/65; G06F 8/75

(52) U.S. Cl. CPC G06F 8/65; G06F 8/75

(57) ABSTRACT

Methods and systems for managing operation of endpoint devices are disclosed. The operation of the endpoint devices may be managed by refactoring services into microservice based implementations. The service refactoring may be automated by monitoring functional flows of the service. The functional flows of the services may be captured in logs produced by the services. The functional flows may be used to identify portions of source code of the services corresponding to each of the functional flows. Microservices may be generated based on the identified portions of the source code.

### FIELD

Embodiments disclosed herein relate generally to device management. More particularly, embodiments disclosed herein relate to systems and methods to secure devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating an endpoint device in accordance with an embodiment.

FIGS. 2A-2B show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing services using endpoint devices. To provide services using endpoint devices, the endpoint devices may host various pieces of software which may provide services.

To improve the services over time, operation of the services may be monitored through logging. The logging may be performed by the software and may enable various types of flows performed by the service to be identified.

The source code for the service may be analyzed based on the flows to discriminate different portions of the source code. The discriminated portions of the source code may be refactored into forms that may be independently compiled into new services (e.g., microservices). The aggregate functionality of the new services may be equivalent to the functionality of the original service. However, the new services may be independently executable thereby enable selective execution of different services. By ensuring that each service corresponds to different functional flows, the number of concurrently executing services may be reduced thereby reducing the computing resource requirements for providing the functionalities of the services, attack surface for providing the functionalities, and improving the serviceability of the service (e.g., different services may be independently updated/modified/replaced).

Thus, embodiments disclosed herein may address, among others, the technical problems of security and limited computing resource availability in systems. By refactoring services into micro-services with equivalent functionality, the computing resources required for providing equivalent functionality of the service may be reduced and the attack surface presented by endpoint devices providing the equivalent functionality may be reduced.

In an embodiment, a method for managing operation of endpoint devices of a deployment is provided. The method may include obtaining logs for operation of a service hosted by at least an endpoint device of the endpoint devices; classifying the logs into flows based on behavior identifiers to obtain flow classified logs, the logs comprising behavior identifiers usable to discriminate flows corresponding to the flows, and the logs being generated by the service during the operation of the service; for a flow of the flows: identifying portions of source code for the service corresponding to the flow using the flow classified logs; obtaining at new service using the portions of the source code; replacing the service using at least the new service to update operation of the deployment; and providing computer implemented services using the updated deployment.

Replacing the service may include identifying a plurality of new services comprising the at least the new service that provide, in aggregate, functionality that is equivalent to functionality of the service; instantiating instances of the plurality of new services on the endpoint devices; and terminating operation of the service.

The service may be a monolithic service (e.g., based on a monolithic code base) and the plurality of new services may be microservices. Each of the microservices may be adapted to perform different flows of the flows.

The logs may be obtained from at least two endpoint devices of the endpoint devices, and the service is distributed across at least the two endpoint devices.

The logs may be generated by software objects hosted by the at least two endpoint devices, and the software objects participate in the service.

The flow may be a domain specific flow or a behavior specific flow.

The flow may include a plurality of steps that when performed accomplish a domain specific goal or a behavior specific goal.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may initiate performance the computer-implemented method when the computer instructions are executed by the processor.

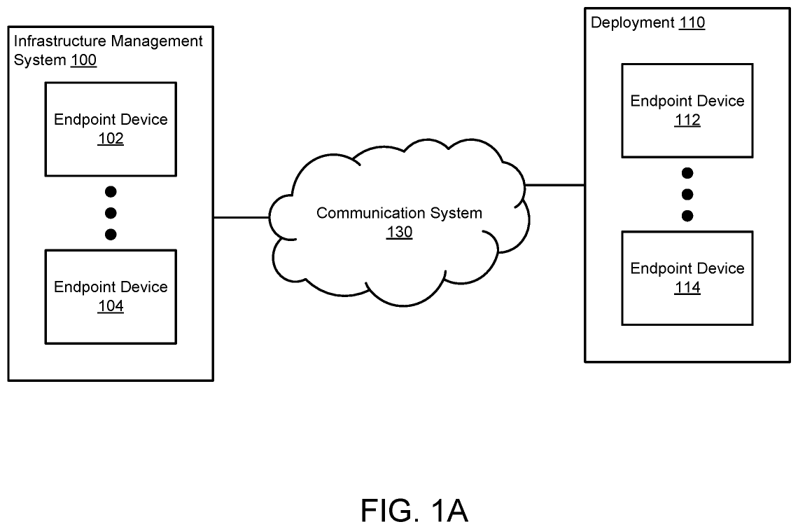

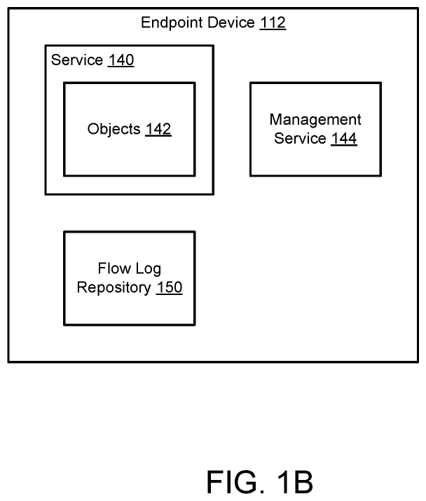

Turning to FIG. 1A, a block diagram illustrating a system in accordance with an embodiment is shown. The system shown in FIG. 1A may provide computer-implemented services. The computer implemented services may include any type and quantity of computer implemented services. For example, the computer implemented services may include data storage services, instant messaging services, database services, transaction processing services, and/or any other type of service that may be implemented with a computing device.

To provide the computer implemented services, the system may include deployment 110. Deployment 110 may include any number of endpoint devices (e.g., 112, 114). The endpoint devices may cooperatively and/or individually provide all, or a portion of the computer implemented services.

To contribute to the computer implemented services, the endpoint devices may host certain software, may be configured in certain manners (e.g., network communication configurations, software/hardware configurations, etc.), and/or may otherwise be modified to meet one or more requirements to contribute to the computer implemented services. Further, groups of endpoint devices may be modified to cooperatively provide various services. For example, some endpoint devices of a group may host some software to provide some functions while other endpoint devices of a group may host different software to provide other functions which, in aggregate, allow desired computer implemented services to be provided.

However, any of the services may be provided using monolithic code base. For example, the code base for a service may include code for all of the functionalities performed by the service. When compiled and hosted by endpoint devices 112-114, only a small portion of the functionalities of the monolithic code base may be used in practice resulting in inefficient use of limited computing resources of endpoint devices 112-114.

For example, the resulting executable code obtained using the monolithic code base may consume larger amounts of computing resources of endpoint devices 112-114 than would be required to be used if the executable code only included those functionalities that are frequently used. Further, when such executable code derived from monolithic code base is executed, the number of attack vectors may be larger than the attack vectors that would be present if only executable code that only includes those functionalities that are frequently used is executed. Thus, the use of executable code obtained using the monolithic code base may introduce more vulnerabilities in the operation of the endpoint devices of deployment 110.

In general, embodiments disclosed herein may provide methods, systems, and/or devices for refactoring services. To refactor services, functional flows performed by the services may be identified using logs generated by executing instances of the functional flows.

A functional flow may be a set of actions performed to accomplish one or more goals. The functional flows may be domain specific functional flows (e.g., relate to a need or a requirement of a domain such as a security need) or behavior specific flows (e.g., relate to activities performed as part of a service).

When a functional flow is identified, the portion of the source code of the service corresponding to the functional flow may be discriminated from other source code for the service. The portion of the source code may be used to obtain a new service (e.g., a microservice) for the functional flow. Any number of new services for a service may be obtained. In aggregate, the activity of the new services may be equivalent to (i.e., a replacement for) the activity of the service.

Once the new services for the service are obtained, the service hosted by the endpoint devices of the deployment may be replaced with the new services. Consequently, when the new services are performed, the resulting attack surface of the endpoint devices may be reduced (e.g., only some of the new services may be executing at any time) and the computing resource use efficiency for the replaced service may be improved (e.g., only some of the new services may be executing at any time).

For example, if operation of a service is monitored and four functional flows are identified, then four new services may be generated. However, during regular operation of the service, only two of the four functional flows may be performed regularly. Consequently, when the new services replace the service, only executable code corresponding to the two functional flows may be regularly loaded and executed. Accordingly, the executed code corresponding to the other two flows may only be loaded and executed intermittently. Thus, the attack surface and computational resource requirements of the refactored service (e.g., the microservice implementation) may be reduced when compared to the original service.

By doing so, embodiments disclosed herein may provide a system that continuously and at least semi-automatically improves the security and resource efficiency of operation of the system over time.

To provide the above noted functionality, the system of FIG. 1A may include infrastructure management system 100, deployment 110, and communication system 130. Each of these components is discussed below.

Infrastructure management system 100 may facilitate management of deployment 110. Infrastructure management system 100 may include any number of endpoint devices (e.g., 102, 104). The endpoint devices may be used by administrators, computer programmers, and/or other persons that manage deployment 110 to provide desired computer implemented services.

To manage deployment 110, the endpoint devices (e.g., 102-104) may be used to refactor services provided by deployment 110. To do so, endpoint devices 102-104 may host (i) source code repositories for services, (ii) integrated development environments or other software development systems (which may be entirely automated, semi-automated with user input, etc.), (iii) automation frameworks for retrieving logs and/or other information from deployment 110 and managing deployed services (e.g., to facilitate replacement of services with refactored services), and/or (iv) other tools for management of deployment 110.

Deployment 110, as noted above, may provide computer implemented services. To provide the computer implemented services, the endpoint devices of deployment 110 may host various services (e.g., which may be implemented using instances of microservices). Refer to FIG. 1B for additional details regarding endpoint devices of deployment 110.

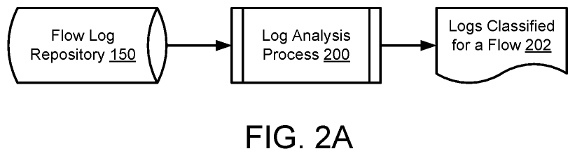

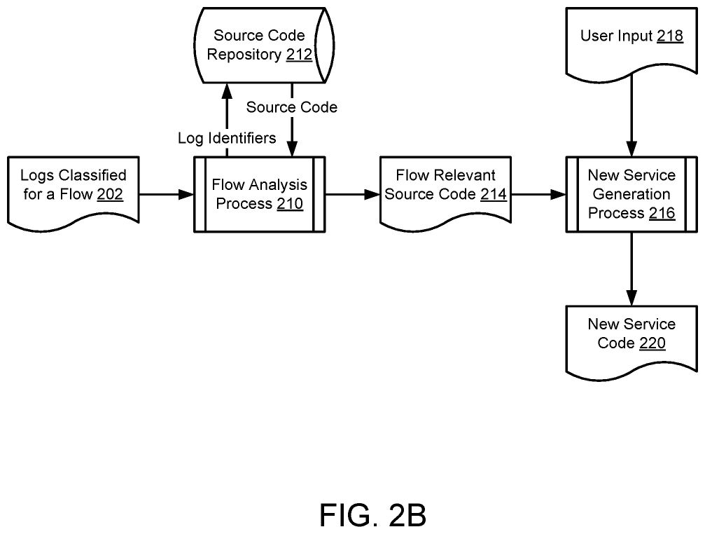

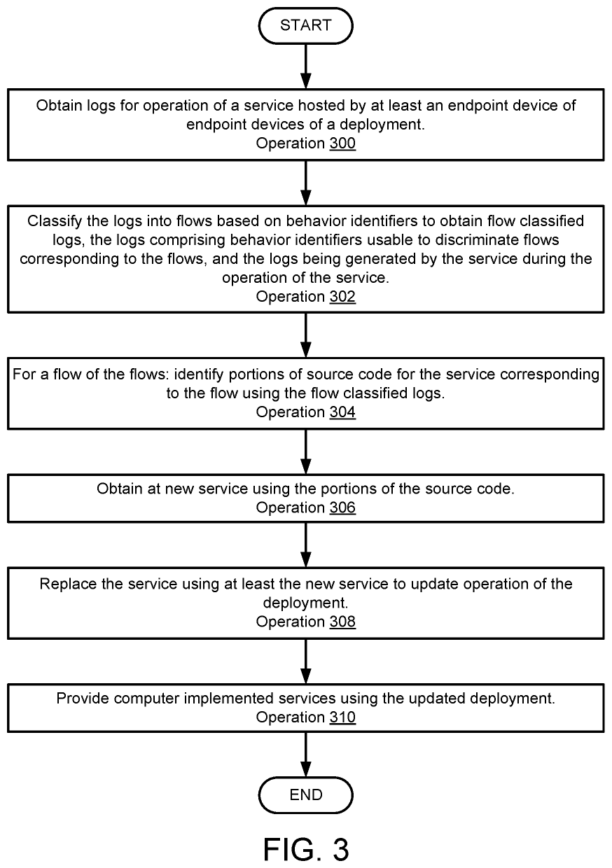

When providing their functionality, any of (and/or components thereof) infrastructure management system 100 and/or deployment 110 may perform all, or a portion, of the actions and methods illustrated in FIGS. 2A-3.

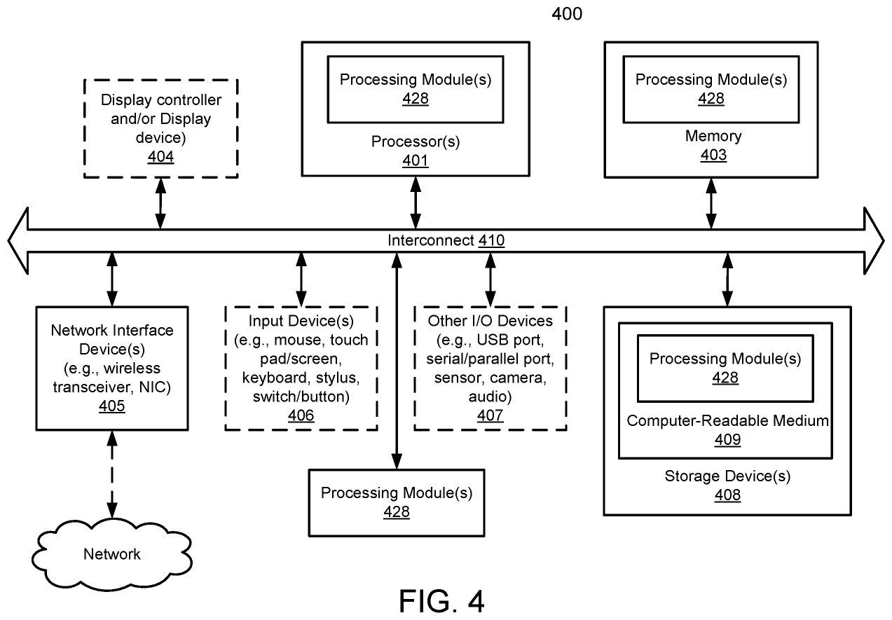

Any of (and/or components thereof) infrastructure management system 100 and deployment 110 may be implemented using a computing device (also referred to as a data processing system, any of endpoint devices 102-104 and 112-114 may be implemented using data processing systems) such as a host or a server, a personal computer (e.g., desktops, laptops, and tablets), a “thin” client, a personal digital assistant (PDA), a Web enabled appliance, a mobile phone (e.g., Smartphone), an embedded system, and/or any other type of data processing device or system. For additional details regarding computing devices, refer to FIG. 4.

Any of the components illustrated in FIG. 1A may be operably connected to each other (and/or components not illustrated) with communication system 130. In an embodiment, communication system 130 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1A as including a limited number of specific components, a system in accordance with an embodiment may include fewer, additional, and/or different components than those illustrated therein.

Turning to FIG. 1B, a block diagram of endpoint device 112 in accordance with an embodiment is shown. Deployment 110 may include any number of endpoint devices similar to endpoint device 112.

Endpoint device 112 may host any number of instances of service 140 and management service 144. Service 140 may correspond to any number of instances of executing computer code for various applications. Service 140 may provide any number and type of computer implemented services in isolation and/or in combination with services hosted by other endpoint devices.

When executing, service 140 may include any number of software objects 142. A software object may be an executing entity corresponding to a portion of executable computer code. Different software objects may perform similar or different functions.

During execution, software objects 142 may generate logs of activities performed during the execution. The logs may include identifiers of functional flows being performed. For example, each function of the executable code may generate an output including an identifier of the function when the function is executed.

Each function may include any numbers of steps (e.g., a sub-portion of the function). Like the function, the executable code corresponding to each step may also output an identifier for the step.

The identifier for a function (e.g., when generated by the service) and the steps may be time stamped and added to a data structure (e.g., a log for the function). In this manner, logs corresponding to each function invocation and steps performed in the invocation of the function may be documented.

Overtime as the logs are generated, the logs may be added to flow log repository 150. Thus, flow log repository 150 may include time stamped logs of function invocations by the service during regular operation of the service. Accordingly, the typical usage pattern of functional flow for the service may be identified. These usage patterns may be driven by real world use of the service (e.g., as opposed to syntactic analysis of code bases). Consequently, the resulting identified functional flows, rates of use of different functional flows, etc. may be better aligned with actual use when compared to functional flows based on code repositories.

The identifiers generated during function invocation may be set, for example, by an organization, developer, or other person. To do so, for example, the source code for a service may be updated by a subject matter expert, via an automated system (e.g., using a large language model or other automated system), and/or via other method to add code to generate the identifiers during execution of the compiled source code. The code may be added to different functions within the source code.

In another example, the compiled code may be analyzed to identify signatures of the compiled code corresponding to the different functions. During execution of the compiled code, these signature in the execution may be identified and another program or framework may generate corresponding identifiers (e.g., as set previously) for the function invocation and steps.

To facilitate use of flow log repository 150 and management of services 140, management service 144 may be hosted by endpoint device 112. Management service 144 may be an automated framework for (i) retrieving information from flow log repository 150 (e.g., for infrastructure management systems), and (ii) managing services hosted by endpoint device 112 by monitoring, terminating, and replacing the services over time as refactored services for monolithic code base derived services become available.

While illustrated in FIG. 1B with respect to one service instance, it will be appreciated that endpoint device 112 may host any number of instances of services.

While illustrated in FIG. 1B as including a limited number of specific components, an endpoint device in accordance with an embodiment may include fewer, additional, and/or different components than those illustrated therein.

To further clarify embodiments disclosed herein, data flow diagrams in accordance with an embodiment are shown in FIGS. 2A-2B. In the diagrams, flows of data and processing of data are illustrated using different sets of shapes. A first set of shapes (e.g., 202, 214, etc.) is used to represent data structures, a second set of shapes (e.g., 200, 210, etc.) is used to represent processes performed using and/or that generate data, and a third set of shapes (e.g., 212, etc.) is used to represent large scale data structures such as databases.

Turning to FIG. 2A, a first data flow diagram in accordance with an embodiment is shown. The first data flow diagram may illustrate data used in and data processing performed in operation of services.

As discussed above, during operation of services hosted by deployments, the services may generate logs of function invocations along with step invocations. Once obtained, the content of the logs may be classified by log analysis process 200 to obtain logs classified for a flow 202.

During log analysis process 200, the logs from flow log repository 150 may be analyzed to identify flows performed by the service. For example, for a given flow, logs for the flow may be collected. The logs for the flow may be discriminated from logs for other flows based on the identifiers in the respective logs. Each log may include, for example, a domain flow identifier, a behavior flow identifier, and/or other information (e.g., steps). Thus, all of the logs corresponding to a given type of flow (e.g., a combination of domain flow and behavior flow identifiers) may be identified.

The logs for the flow may then be analyzed to identify the steps performed in the flow to obtain mappings between functions, steps of the functions, and corresponding logs. The resulting mappings and/or the corresponding logs themselves may be added to logs classified for a flow 202. Any number of logs classified for a flow 202 may be generated for different flows.

Once obtained, the logs classified for a flow may be provided to the infrastructure management system. Once obtained, the logs may be added to a repository or other data structure for retention, organization, and future use.

Turning to FIG. 2B, a second data flow diagram in accordance with an embodiment is shown. The second data flow diagram may illustrate data used in and data processing performed in service refactoring and/or deployment.

To refactor a service, logs classified for a flow 202 may be ingested by flow analysis process 210. During flow analysis process 210, the functions and steps from logs classified for a flow 202 may be used to identify corresponding portions of source code for a service. For example, the identifiers for the flow and/or steps may be used to search source code repository 212.

Source code repository 212 may include source code (e.g., code that may be compiled to obtain executable code) for any number of services. The source code for a service may be searched for the function identifiers and/or step identifiers (e.g., as discussed above, the source code may include lines that cause outputs of these identifiers to be generated and used to generate logs during operation of the service). The portion of the source code (e.g., a function) in which each identifier is included may be obtained from source code repository 212. The obtained portions may be aggregated as flow relevant source code 214. Flow relevant source code 214 may include the portions of the source code relevant to the flow from logs classified for a flow 202.

Once obtained, flow relevant source code 214 may be ingested by new service generation process 216. During new service generation process 216, the source code from flow relevant source code 214 may be refactored into a form that may be compiled to obtain executable code. For example, the source code may be (i) automatically refactored using a large language model into a form that may be compiled into executable code, (ii) may be refactored based on user input 218 from a software developer, and/or may be refactored in other manners.

In this manner, a new source code base that may be compiled into executable code (e.g., a microservice) may be obtained. The resulting executable code may include a sub-set of the functionalities of the original service. The aforementioned process may be repeated for any number of functional flows derived from the service. Consequently, any number of microservices may be obtained and which may, in aggregate, include the same functionality of the original service. However, unlike the original service, the new services may not all need to be executing simultaneously. Thus, only some of the new services may be executing at any given time thereby decreasing the computing resource cost for providing the micro-service equivalent version of the service and attack surface of the micro-service equivalent version of the service.

The resulting refactored source code may be new service code 220. Once new service code 220 corresponding to the different functional flows of the service are obtained, the aggregate new service code may be independently compiled into executable code.

Once obtained, the executable code may be deployed to the deployment. During deployment, the new executable code may begin to execute and the original service may be terminated. In this manner, the deployment may be updated to obtain an updated deployment. The updated deployment may provide computer implemented services (e.g., equivalent) in a more computationally efficient manner and with reduced attack surface thereby reducing the likelihood of compromise of the deployment.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1A may perform various methods to manage operation of endpoint devices of a deployment through automatic refactoring of source code on which various services are based into micro-service equivalent implementations. FIG. 3 illustrates a method that may be performed by the components of the system of FIG. 1A. In the diagram discussed below and shown in FIG. 3, any of the operations may be repeated, performed in different orders, and/or performed in parallel with or in a partially overlapping in time manner with other operations.

Turning to FIG. 3, a flowchart illustrating a method of managing the operation of endpoint devices in accordance with an embodiment is shown. Any of the component shown in FIG. 1A may perform all, or a portion, of the method shown in FIG. 3.

At operation 300, logs of operation of a service hosted by at least an endpoint device of endpoint devices of a deployment is obtained. The logs may be obtained by (i) reading the logs from storage, (ii) receiving the logs from another device, (iii) generation of the logs based on the operation of the service, and/or via other methods. For example, execution of the service may cause the logs to be generated. The logs may include identifiers of functional flows, steps thereof, and/or other information regarding operation of the service.

At operation 302, the logs are classified into flows based on behavior identifiers to obtain flow classified logs. The logs may include the behavior identifiers and that are usable to discriminate flows corresponding to the flows. The logs may be generated by the service during the operation of the service. The logs may be classified by comparing identifiers for the flows to identifiers included in the logs. Logs with matching identifiers may be classified for each flow.

At operation 304, for a flow of the flows, portions of source code for the service corresponding to the flow are identified using the flow classified logs. For example, the identifiers from the logs classified for the flow may be used to identify the portions of the source code. As discussed above, the source code may include functions or other macro sections that include lines which include the identifiers. Each macro section of the source code that includes the identifiers may be identified as part of the portions of the source code of the service that corresponds to the flow.

At operation 306, a new service is obtained using the portions of the source code. The new service may be obtained by (i) refactoring the portions of the source code into a form that may be compiled, and (ii) compiling the refactored portions of the source code to obtain executable code. The portions of the source code may be refactored automatically (e.g., using a large language model or other automated analysis entity, the portions of the source code may be ingested and the refactored code may be output), semiautomatically (e.g., a software developer may check the output of the large language model), and/or manually (e.g., the software developer may revise the code to obtain a form that may be compiled and/or able to operate with other refactored code for the service).

Any number of new services may be obtained using operations 304-306. Consequently, a micro-service based implementation of the service may be obtained, with different microservice corresponding to different domain and/or behavior flows from the original service.

At operation 308, the service is replaced using at least the new service to update operation of the deployment. The service may be replaced by (i) terminating the service, and (ii) initiating operation of the at least the new service and any other services of the microservice equivalent implementation of the service.

The service may be replaced using an automation framework. The automation may include agents hosted by the endpoint devices of the deployment. The agents may obtain copies of the micro-service implementation of the service and initiate execution of the micro-service implementation. Once executing, the original service may be terminated gracefully with handover of responsibility to the micro-service implementation of the service.

For example, to gracefully handover, the micro-service implementation may include substantially similar application programming interfaces to the service. Thus, once executing, other services may continue to operate in cooperation with the micro-service implementation of the service without needing to update their operation.

At operation 310, computer implemented services are provided using the updated deployment. The provided computer implemented services may consume fewer computing resources and may have a reduced surface area for attacks than the original service (e.g., due to the micro-service implementation).

The method may end following operation 310.

Thus, using the method illustrated in FIG. 3, a system in accordance with embodiments disclosed herein may provide computer implemented services in a more computationally efficient manner and have a reduced surface area for attack when compared to services provided using services derived from monolithic source code bases.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of endpoint devices of a deployment, the method comprising:
obtaining logs for operation of a service hosted by at least an endpoint device of the endpoint devices;
classifying the logs into flows based on behavior identifiers to obtain flow classified logs, the logs comprising behavior identifiers usable to discriminate flows corresponding to the flows, and the logs being generated by the service during the operation of the service;
for a flow of the flows:
identifying portions of source code for the service corresponding to the flow using the flow classified logs;
obtaining at new service using the portions of the source code; and
replacing the service using at least the new service to update operation of the deployment to obtain an updated deployment; and
providing computer implemented services using the updated deployment.

2. The method of claim 1, wherein replacing the service comprises:
identifying a plurality of new services comprising the at least the new service that provide, in aggregate, functionality that is equivalent to functionality of the service;
instantiating instances of the plurality of new services on the endpoint devices; and
terminating operation of the service.

3. The method of claim 2, wherein the service is a monolithic service and the plurality of new services are microservices.

4. The method of claim 3, wherein each of the microservices is adapted to perform different flows of the flows.

5. The method of claim 1, wherein the logs are obtained from at least two endpoint devices of the endpoint devices, and the service is distributed across at least the two endpoint devices.

6. The method of claim 5, wherein the logs are generated by software objects hosted by the at least two endpoint devices, and the software objects participate in the service.

7. The method of claim 1, wherein the flow is a domain specific flow or a behavior specific flow.

8. The method of claim 7, wherein the flow comprises a plurality of steps that when performed accomplish a domain specific goal or a behavior specific goal.

9. A non-transitory machine-readable medium having instructions stored therein, which when executed by a processor, cause the processor to perform operations for operation of endpoint devices of a deployment, the operations comprising:
obtaining logs for operation of a service hosted by at least an endpoint device of the endpoint devices;
classifying the logs into flows based on behavior identifiers to obtain flow classified logs, the logs comprising behavior identifiers usable to discriminate flows corresponding to the flows, and the logs being generated by the service during the operation of the service;
for a flow of the flows:
identifying portions of source code for the service corresponding to the flow using the flow classified logs;
obtaining at new service using the portions of the source code; and
replacing the service using at least the new service to update operation of the deployment to obtain an updated deployment; and
providing computer implemented services using the updated deployment.

10. The non-transitory machine-readable medium of claim 9, wherein replacing the service comprises:
identifying a plurality of new services comprising the at least the new service that provide, in aggregate, functionality that is equivalent to functionality of the service;
instantiating instances of the plurality of new services on the endpoint devices; and
terminating operation of the service.

11. The non-transitory machine-readable medium of claim 10, wherein the service is a monolithic service and the plurality of new services are microservices.

12. The non-transitory machine-readable medium of claim 11, wherein each of the microservices is adapted to perform different flows of the flows.

13. The non-transitory machine-readable medium of claim 9, wherein the logs are obtained from at least two endpoint devices of the endpoint devices, and the service is distributed across at least the two endpoint devices.

14. The non-transitory machine-readable medium of claim 13, wherein the logs are generated by software objects hosted by the at least two endpoint devices, and the software objects participate in the service.

15. The non-transitory machine-readable medium of claim 9, wherein the flow is a domain specific flow or a behavior specific flow.

16. The non-transitory machine-readable medium of claim 15, wherein the flow comprises a plurality of steps that when performed accomplish a domain specific goal or a behavior specific goal.

17. A management system, comprising:
a processor; and
a memory coupled to the processor to store instructions, which when executed by the processor, cause the processor to perform operations for operation of endpoint devices of a deployment, the operations comprising:
obtaining logs for operation of a service hosted by at least an endpoint device of the endpoint devices;
classifying the logs into flows based on behavior identifiers to obtain flow classified logs, the logs comprising behavior identifiers usable to discriminate flows corresponding to the flows, and the logs being generated by the service during the operation of the service;
for a flow of the flows:
identifying portions of source code for the service corresponding to the flow using the flow classified logs;
obtaining at new service using the portions of the source code; and
replacing the service using at least the new service to update operation of the deployment to obtain an updated deployment; and
providing computer implemented services using the updated deployment.

18. The management system of claim 17, wherein replacing the service comprises:
identifying a plurality of new services comprising the at least the new service that provide, in aggregate, functionality that is equivalent to functionality of the service;
instantiating instances of the plurality of new services on the endpoint devices; and
terminating operation of the service.

19. The management system of claim 18, wherein the service is a monolithic service and the plurality of new services are microservices.

20. The management system of claim 19, wherein each of the microservices is adapted to perform different flows of the flows.
